(19) United States
(12) Patent Application Publication
(10) Pub. No.: US 2026/0050776 A1
(43) Pub. Date: Feb. 19, 2026

(54) Cloud-Edge Collaborative Data Processing Method and System, Device, and Storage Medium

(71) Applicant: PENG CHENG LABORATORY, Shenzhen (CN)

(72) Inventors: Jingwei Tan, Shenzhen (CN); Fagui Liu, Shenzhen (CN); Bin Wang, Shenzhen (CN); Yongheng Liu, Shenzhen (CN)

(21) Appl. No.: 19/282,086

(22) Filed: Jul. 28, 2025

(30) Foreign Application Priority Data
Aug. 19, 2024 (CN) 202411142310.7

(51) Int. Cl. G06N 3/0495; G06N 3/0455; G06N 3/098

(52) U.S. Cl. CPC G06N 3/0495; G06N 3/0455; G06N 3/098

(57) ABSTRACT

A cloud-edge collaborative data processing method and system, a device, and a storage medium are provided, relating to the field of telecommunication technology. The method includes extracting, in an edge encoder, intermediate features of data to be processed, inputting the intermediate features into a lightweight edge decoder for decoding to obtain an edge decoding result; and in response to a feature uncertainty of the edge decoding result being less than or equal to a preset threshold, taking the edge decoding result as a target processing result, or in response to the feature uncertainty being greater than the preset threshold, compressing the intermediate features using an edge compression model and then sending the compressed intermediate features to a cloud server in the cloud-edge collaborative data processing system.

### CROSS-REFERENCE TO RELATED APPLICATION

This application claims priority to Chinese Patent Application No. 202411142310.7 filed Aug. 19, 2024, the disclosure of which is hereby incorporated by reference in its entirety.

### BACKGROUND

### Technical Field

The present disclosure relates to the field of telecommunication technology, particularly to a cloud-edge collaborative data processing method and system, a device, and a storage medium.

### TECHNICAL CONSIDERATIONS

Cloud-edge collaborative inference is an architecture in the field of edge computing that integrates the advantages of cloud computing and edge computing. By performing data processing and analysis at both the cloud and the edge, more efficient and low-latency data processing and decision-making processes are achieved.

In the existing technology, due to the consideration that the computing capability of the edge is generally lower than that of the cloud, the edge often performs simple preprocessing on input data, compresses the data, and then sends compressed data to the cloud, where most of the processing work is completed. However, this processing method results in a large amount of data transmission, leading to high communication overhead in the collaborative process between the cloud and the edge.

### SUMMARY

The main objective of the embodiments of the present disclosure is to propose a cloud-edge collaborative data processing method and system, a device, and a storage medium to reduce communication overhead in cloud-edge collaborative processing.

In order to achieve the above objective, an embodiment of a first non-limiting aspect of the present disclosure provides a cloud-edge collaborative data processing method, which is applied to an edge server in a cloud-edge collaborative data processing system, where an edge encoder, at least one lightweight edge decoder corresponding to different processing tasks, and an edge compression model are deployed on the edge server. The method includes:
acquiring data to be processed from a terminal device and sending the data to be processed to the edge encoder for feature extraction to obtain intermediate features;
for each processing task:
   inputting the intermediate features into the respective lightweight edge decoder for decoding to obtain an edge decoding result, and calculating an entropy of the edge decoding result as a feature uncertainty;
   in response to the feature uncertainty being less than or equal to a preset threshold, taking the edge decoding result as a target processing result corresponding to such processing task for the data to be processed; and
   in response to the feature uncertainty being greater than the preset threshold, performing feature compression on the intermediate features using the edge compression model to obtain intermediate compressed features, and sending the intermediate compressed features to a cloud server in the cloud-edge collaborative data processing system,
where a cloud decompression model and at least one cloud decoder that together with the edge encoder constitutes a cloud-edge collaborative data processing model are deployed on the cloud server, the at least one lightweight edge decoder corresponds to the at least one cloud decoder, the cloud decompression model is configured to decompress the intermediate compressed features to obtain intermediate decompressed features, and the at least one cloud decoder is configured to decode the intermediate decompressed features to obtain a cloud decoding result, which is taken as the target processing result corresponding to the processing tasks.

In some embodiments, the edge compression model includes at least a quantization model, and performing the feature compression on the intermediate features using the edge compression model to obtain the intermediate compressed features includes:
quantizing the intermediate features using the quantization model to obtain intermediate quantized features; and
performing arithmetic encoding on the intermediate quantized features to obtain the intermediate compressed features in the form of a binary string.

In some embodiments, the edge compression model includes at least a side information encoder, a statistical parameter encoder, and a side information decoder, and performing the feature compression on the intermediate features using the edge compression model to obtain the intermediate compressed features includes:
inputting the intermediate features into the side information encoder for feature correction to obtain statistical hidden features, and quantizing the statistical hidden features to obtain quantized hidden features;
inputting the quantized hidden features into the statistical parameter encoder for encoding to obtain side information compressed features;
inputting the quantized hidden features into the side information decoder for decoding to obtain statistical parameters, and correcting the intermediate quantized features using the statistical parameters to obtain simulated compressed features; and
obtaining the intermediate compressed features based on the simulated compressed features and the side information compressed features.

In some embodiments, the method further includes:
designating at least one of the edge encoder, the at least one lightweight edge decoder, and the edge compression model as a first base network;
acquiring at least one of first convolutional layer parameters of a convolutional layer or first fully connected layer parameters of a fully connected layer in the first base network, and performing singular value decomposition on the first convolutional layer parameters and/or the first fully connected layer parameters to obtain a first singular value matrix and a first default matrix;
acquiring a predetermined first delta value, obtaining a first compression matrix based on the first delta value and the first singular value matrix, and obtaining first compression model parameters based on the first compression matrix and the first default matrix; and
performing parameter update on the first base network based on the first compression model parameters to obtain an updated first base network.

In order to achieve the above objective, an embodiment of a second non-limiting aspect of the present disclosure provides a cloud-edge collaborative data processing method, which is applied to a cloud server in a cloud-edge collaborative data processing system, where a cloud decompression model and at least one cloud decoder that together with the edge encoder constitutes a cloud-edge collaborative data processing model are deployed on the cloud server. The method includes:
receiving intermediate compressed features sent from an edge server, where the intermediate compressed features are obtained by any of the cloud-edge collaborative data processing method of the first non-limiting aspect;
decompressing the intermediate compressed features using the cloud decompression model to obtain intermediate decompressed features; and
selecting the corresponding cloud decoder based on the processing task(s), and inputting the intermediate decompressed features into the cloud decoder for decoding to obtain a cloud decoding result, which is taken as a target processing result corresponding to the processing task(s).

In some embodiments, the cloud decompression model includes at least a cloud side information decoder and a statistical parameter decoder, and in response to the intermediate compressed features being obtained from simulated compressed features and side information compressed features, decompressing the intermediate compressed features using the cloud decompression model to obtain intermediate decompressed features includes:
acquiring the simulated compressed features and the side information compressed features from the intermediate compressed features;
inputting the side information compressed features into the statistical parameter decoder for decoding to obtain decoded hidden features;
inputting the decoded hidden features into the cloud side information decoder for decoding to obtain cloud statistical parameters; and
performing arithmetic decoding on the simulated compressed features using the cloud statistical parameters to obtain the intermediate decompressed features.

In some embodiments, the method further includes:
designating at least one of the cloud decompression model or the at least one cloud decoder as a second base network;
acquiring at least one of second convolutional layer parameters of a convolutional layer or second fully connected layer parameters of a fully connected layer in the second base network, and performing singular value decomposition on the second convolutional layer parameters and/or the second fully connected layer parameters respectively to obtain a second singular value matrix and a second default matrix;
acquiring a predetermined second delta value, obtaining a second compression matrix based on the second delta value and the second singular value matrix, and obtaining second compression model parameters based on the second compression matrix and the second default matrix; and performing parameter update on the second base network based on the second compression model parameters to obtain an updated second base network.

In order to achieve the above objective, an embodiment of a third non-limiting aspect of the present disclosure provides a cloud-edge collaborative data processing system, including:
an edge server, on which an edge encoder, at least one lightweight edge decoder corresponding to different processing tasks, and an edge compression model are deployed; and
a cloud server, on which a cloud decompression model and at least one cloud decoder are deployed, the at least one cloud decoder and the edge encoder together constituting a cloud-edge collaborative data processing model, and the at least one cloud decoder corresponding to the at least one lightweight edge decoder, where
the edge server is configured to perform feature extraction using the edge encoder on the data to be processed from a terminal device to obtain intermediate features, decode, using the at least one lightweight edge decoder, the intermediate features input thereto to obtain an edge decoding result, calculate an entropy of the edge decoding result as a feature uncertainty, and take the edge decoding result as a target processing result for the data to be processed in response to the feature uncertainty being less than or equal to a preset threshold, or perform feature compression on the intermediate features using the edge compression model to obtain intermediate compressed features in response to the feature uncertainty being greater than the preset threshold, and send the intermediate compressed features to the cloud server;
the cloud server is configured to decompress the intermediate compressed features using the cloud decompression model to obtain intermediate decompressed features, and select the corresponding cloud decoder based on the processing task, and input the intermediate decompressed features into the selected cloud decoder for decoding to obtain a cloud decoding result, which is taken as a target processing result corresponding to the processing task.

In some embodiments, a training process of the edge encoder, the edge compression model, the cloud decompression model, and the at least one cloud decoder includes the steps of:
acquiring input sample data;
during the training process, acquiring intermediate training data corresponding to the input sample data, acquiring transmission mutual information of the input sample data and the intermediate training data, and generating an information quantity constraint based on a maximum information quantity and the transmission mutual information;
acquiring cloud inference results corresponding to different processing tasks based on the intermediate training data, generating several items of inference mutual information each between each of the cloud inference results and the intermediate training data, and maximizing the several items of inference mutual information to obtain a compression objective based on Lagrange multipliers each corresponding to a respective processing task;
obtaining an optimization objective based on the transmission mutual information and the compression objective;
obtaining a loss function and an objective upper bound corresponding to the optimization objective based on the input sample data, the intermediate training data, and the cloud inference results; and
under the premise of satisfying the objective upper bound and the information quantity constraint, minimizing a loss value corresponding to the loss function to train the edge encoder, the edge compression model, the cloud decompression model, and the cloud decoder.

In order to achieve the above objective, an embodiment of a fourth non-limiting aspect of the present disclosure provides an electronic device, including a memory and a processor, where the memory stores a computer program which, when executed by the processor, causes the processor to implement the method of the first non-limiting aspect or the second non-limiting aspect.

In order to achieve the above objective, an embodiment of a fifth non-limiting aspect of the present disclosure provides a storage medium storing a computer program which, when executed by a processor, causes the processor to implement the method of the first non-limiting aspect or the second non-limiting aspect.

The cloud-edge collaborative data processing method and system, the device, and the storage medium proposed by the embodiments of the present disclosure acquire data to be processed from a terminal device and send the data to the edge encoder for feature extraction to obtain intermediate features. Next, for each processing task, the intermediate features are input into the respective lightweight edge decoder for decoding to obtain an edge decoding result, and an entropy of the edge decoding result is calculated as a feature uncertainty; In response to the feature uncertainty being less than or equal to a preset threshold, the edge decoding result is taken as a target processing result corresponding to the processing task for the data to be processed, or in response to the feature uncertainty being greater than the preset threshold, feature compression is performed on the intermediate features by using the edge compression model to obtain intermediate compressed features, and the intermediate compressed features are sent to a cloud server in the cloud-edge collaborative data processing system; and the intermediate compressed features are decompressed on the cloud server to obtain intermediate decompressed features, and the intermediate decompressed features are decoded to obtain a cloud decoding result, which is taken as the target processing result corresponding to the processing task. In the embodiments of the present disclosure, the cloud-edge collaborative data processing model is segmented, with one part of the processing occurring at the edge and the other part occurring at the cloud. Through this segmented processing, the data to be processed is transformed into intermediate features of smaller dimensions, and then these intermediate features are compressed to further reduce the amount of data sent from the edge to the cloud, thereby reducing communication overhead. In addition, for different processing tasks, a lightweight model is utilized first to calculate a quick result, and based on the entropy of that result, it is determined whether to select the processing result from the edge or the processing result from the cloud. This dynamic exit mechanism for flexible cloud-edge collaboration selectively compresses part of the data from the full dataset for transmission, which can further reduce the data volume and communication overhead.

### BRIEF DESCRIPTION OF THE DRAWINGS

FIG. 1 is a schematic diagram illustrating the principle of cloud-edge collaborative inference in the existing technology;

FIG. 2 is a schematic diagram illustrating the principle of a cloud-edge collaborative data processing system according to an embodiment of the present disclosure;

FIG. 3 is a schematic diagram illustrating the structure of the cloud-edge collaborative data processing system according to the embodiment of the present disclosure;

FIG. 4 is a flowchart illustrating a cloud-edge collaborative data processing method applied to an edge server according to an embodiment of the present disclosure;

FIG. 5 is a schematic diagram of a dynamic exit mechanism for cloud-edge collaboration according to an embodiment of the present disclosure;

FIG. 6 is a flowchart illustrating the process of a cloud-edge collaborative data processing method according to an embodiment of the present disclosure;

FIG. 7 is a flowchart illustrating feature compression of intermediate features using an edge compression model to obtain intermediate compressed features according to an embodiment of the present disclosure;

FIG. 8 is a flowchart illustrating self-adaptive adjustment of a compression rate at the edge according to an embodiment of the present disclosure;

FIG. 9 is a schematic diagram illustrating adjustment of a compression rate of a first base network according to an embodiment of the present disclosure;

FIG. 10 is a flowchart illustrating a cloud-edge collaborative data processing method applied to a cloud server according to an embodiment of the present disclosure;

FIG. 11 is a flowchart illustrating decompression of intermediate compressed features using a cloud decompression model to obtain intermediate decompressed features;

FIG. 12 is a flowchart illustrating a training process of an edge encoder, an edge compression model, a cloud decompression model, and a cloud decoder in a cloud-edge collaborative data processing system according to an embodiment of the present disclosure;

FIG. 13 shows experimental results of accuracy with image classification and reconstruction tasks according to an embodiment of the present disclosure;

FIG. 14 shows the accuracy loss with a dynamic exit mechanism for cloud-edge collaboration under different network availability according to an embodiment of the present disclosure; and

FIG. 15 is a schematic diagram of a hardware structure of an electronic device according to an embodiment of the present disclosure.

### DETAILED DESCRIPTION

In order to make the objectives, technical schemes and advantages of the present disclosure clearer, the present disclosure is further described in detail in conjunction with the accompanying drawings and embodiments. It should be understood that the particular embodiments described herein are only intended to explain the present disclosure, and are not intended to limit the present disclosure.

It is to be noted that although a functional module division is shown in a schematic diagram of an apparatus and a logical order is shown in a flowchart, the steps shown or described may be executed, in some cases, with a different module division from that of the apparatus or in a different order from that in the flowchart.

Unless otherwise defined, all the technical and scientific terms used herein have the same meanings as those commonly understood by those skilled in the art to which the present disclosure pertains. The terminology used herein is for the purpose of describing embodiments of the present disclosure only and is not intended to limit the present disclosure.

First, some terms involved in the present disclosure are explained.

Artificial intelligence (AI) is a new technological science that researches and develops theories, methods, technologies, and application systems configured to simulate, extend, and enhance human intelligence. Artificial intelligence is a branch of computer science that attempts to understand the essence of intelligence and produce a new type of intelligent machine that can respond in a manner similar to human intelligence. Research in this field includes robotics, language recognition, image recognition, natural language processing, expert systems, etc. Artificial intelligence can simulate the information processing of human consciousness and thinking. Artificial intelligence (AI) is also a theory, method, technology, or application system that uses digital computers or machines controlled by digital computers to simulate, extend, and expand human intelligence, sensing the environment, acquiring knowledge, and using knowledge to obtain the best result.

The term “configured to,” as used herein, may refer to an arrangement of software, device(s), and/or hardware for performing and/or enabling one or more functions (e.g., actions, processes, steps of a process, and/or the like). For example, “a server configured to” or “a processor configured to” may refer to a server or processor that executes software instructions (e.g., program code) that cause the server or processor to perform one or more functions.

Cloud-edge collaborative inference is an architecture in the field of edge computing that integrates the advantages of cloud computing and edge computing. By performing data processing and analysis at both the cloud and the edge, more efficient and low-latency data processing and decision-making processes are achieved.

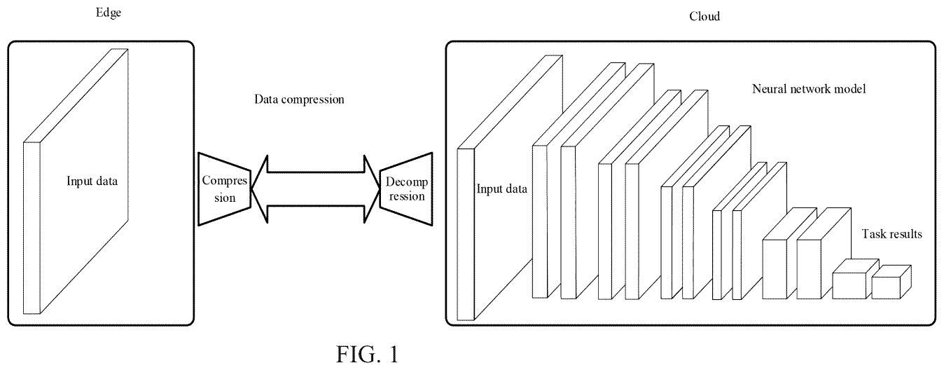

In the existing technology, due to the consideration that the computing capability of the edge is generally lower than that of the cloud, the edge often performs simple preprocessing on input data, compresses the data and then sends compressed data to the cloud, where most of the processing work is completed. Please refer to FIG. 1. FIG. 1 is a schematic diagram illustrating the principle of cloud-edge collaborative inference in the existing technology; In FIG. 1, input data is compressed at the edge and then sent to the cloud, where the decompression process is performed to obtain the input data, which is then processed in a neural network model to obtain the task result. Even if the neural network model is segmented and deployed separately at the edge and the cloud, with part of the neural network offloaded from the edge to the cloud, communication overhead will still be introduced during the neural network inference process. This is mainly because when the edge transmits the intermediate feature data at the model segmentation point to the cloud, the size of the intermediate feature data and the quality of the communication connection directly affect the inference latency. Therefore, in the collaborative process between the cloud and the edge in the existing technology, communication overhead is relatively high.

In view of this, according to embodiments of the present disclosure, a cloud-edge collaborative data processing method and system, a device, and a storage medium are provided. The cloud-edge collaborative data processing model is segmented, with one part of the processing occurring at the edge and the other part occurring at the cloud. Through this segmentation processing, the data to be processed is transformed into intermediate features of smaller dimensions, and then these intermediate features are compressed to further reduce the amount of data sent from the edge to the cloud, thereby reducing communication overhead. In addition, for different processing tasks, a lightweight model is adopted first to calculate a quick result, and based on the entropy of that result, it is determined whether to select the processing result from the edge or the processing result from the cloud. This flexible dynamic exit mechanism for cloud-edge collaboration selectively compresses part of the data from the full dataset for transmission, which can further reduce the data volume and communication overhead.

A cloud-edge collaborative data processing method and system, a device, and a storage medium according to the present disclosure are provided, which are specifically explained through the following embodiments. First, the cloud-edge collaborative data processing method in the embodiments of the present disclosure is described.

The embodiments of the present disclosure can acquire and process relevant data based on artificial intelligence technology. Artificial intelligence (AI) is a theory, method, technology, or application system that uses digital computers or machines controlled by digital computers to simulate, extend, and expand human intelligence, sense the environment, acquire knowledge, and use knowledge to obtain the best result. In other words, artificial intelligence is an integrated technology of computer science that attempts to understand the essence of intelligence and produce a new type of intelligent machine that can respond in a manner similar to human intelligence. Artificial intelligence also involves the study of design principles and implementation methods for various intelligent machines, enabling machines to have sensing, reasoning, and decision-making capabilities.

Artificial intelligence technology is a comprehensive discipline that covers a wide range of fields, including both hardware-level technologies and software-level technologies. Fundamental technologies of artificial intelligence generally include technologies such as sensors, dedicated artificial intelligence chips, cloud computing, distributed storage, big data processing technologies, operating/interacting systems, and mechatronics. Artificial intelligence software technologies mainly include major branches such as computer vision technology, speech processing technology, natural language processing technology, and machine learning/deep learning.

The cloud-edge collaborative data processing method provided by the embodiments of the present disclosure relates to the field of communication technology. The cloud-edge collaborative data processing method provided by the embodiments of the present disclosure may be applied in terminal devices, may also be applied in server ends, and may also be a computer program running on terminal devices or server ends. For example, the computer program may be a native program or software module in an operating system; it may be a native application (APP), which needs to be installed in the operating system to run, such as a client supporting cloud-edge collaborative data processing, or it may be a mini-program, which only needs to be downloaded to the browser environment to run; or it may also be a mini-program that can be embedded into any APP. In summary, the above computer program can be any form of application, module, or plugin. Here, the terminal device communicates with the server through a network. The cloud-edge collaborative data processing method may be executed by the terminal device or server, or executed collaboratively by the terminal device and server.

In some embodiments, the terminal device may be a smart phone, tablet computer, laptop, desktop computer, or smart watch, etc. In addition, the terminal device may also be a smart vehicle-mounted device. This smart vehicle-mounted device applies the cloud-edge collaborative data processing method of the embodiments to provide relevant services, thereby enhancing the driving experience. The server may be an standalone server, or it may be a cloud server that provides basic cloud computing services such as cloud services, cloud databases, cloud computing, cloud functions, cloud storage, network services, cloud communication, middleware services, domain name services, security services, content delivery networks (CDN), and big data and artificial intelligence platforms; it may also be a service node in a blockchain system, where service nodes in the blockchain system form peer-to-peer (P2P) networks, and the P2P protocol is an application layer protocol running on top of the Transmission Control Protocol (TCP). The terminal device and server can be connected through communication connections such as Bluetooth, universal serial bus (USB), or network, which is not limited in the embodiments.

The present disclosure may be used in a wide variety of general purpose or special purpose computer system environments or configurations, for example: personal computers, server computers, handheld devices or portable devices, tablet devices, multiprocessor systems, microprocessor-based systems, set-top boxes, programmable consumer electronics, network PCs, mini-computers, mainframe computers, and any distributed computing environments that include any of the aforementioned systems or devices, among others. The present disclosure may be described in the general context of computer-executable instructions executed by a computer, such as program modules. Typically, program modules include routines, programs, objects, components, data structures, and the like that perform specific tasks or implement specific abstract data types. The present disclosure may also be practiced in distributed computing environments in which tasks are performed by remote processing devices connected through a communication network. In a distributed computing environment, program modules may be located in local and remote computer storage media, including storage devices.

It should be noted that in various specific embodiments of the present disclosure, when it involves processing data related to user identity or attributes based on user information, user behavior data, user historical data, and user location information, user permission or consent will always be obtained first. Moreover, the collection, use, and processing of these data will comply with relevant national and regional laws, regulations, and standards. In addition, when the embodiments of the present disclosure need to obtain sensitive personal information from users, separate permission or consent from the user will be obtained through pop-ups or redirection to confirmation pages, and only after obtaining explicit separate permission or consent from the user will necessary user-related data be obtained to enable the normal operation of the embodiments of the present disclosure.

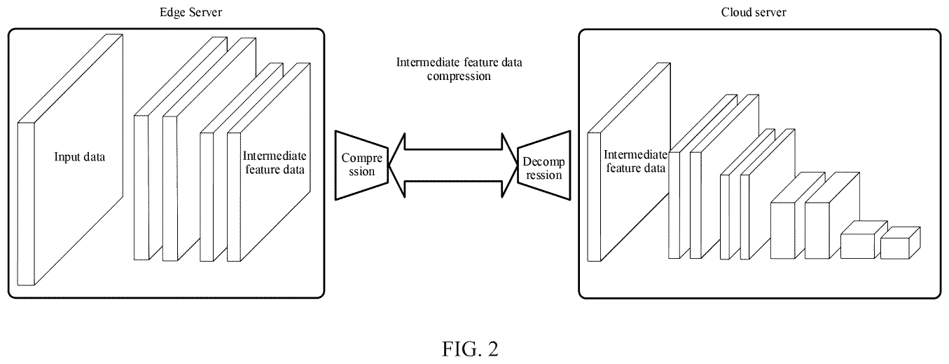

First, the cloud-edge collaborative data processing system provided by the embodiments of the present disclosure is described. Please refer to FIG. 2. FIG. 2 is a schematic diagram illustrating the principle of a cloud-edge collaborative data processing system according to an embodiment of the present disclosure. The cloud-edge collaborative data processing model is segmented into two parts, with one part deployed on an edge server (hereinafter referred to as the edge) and the other part deployed on a cloud server (hereinafter referred to as the cloud). In the processing procedure at the edge, the intermediate input data is processed into low-dimensional intermediate features, which are then compressed and transmitted to the cloud. The cloud decompresses the compressed data to obtain the intermediate features, and then uses the other part of the model to process the intermediate features to obtain the final task result.

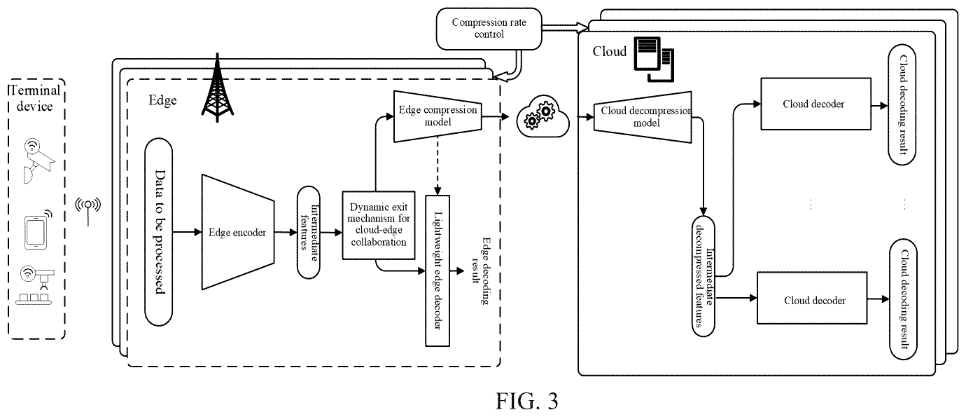

In an embodiment, referring to FIG. 3, FIG. 3 is a schematic diagram illustrating the structure of the cloud-edge collaborative data processing system according to an embodiment of the present disclosure. In FIG. 3, the terminal device acts as a sensor for data collection, obtaining different data to be processed. Here, the data to be processed may be collected images, audio, or video, and each type of data to be processed can correspond to at least one different processing task. That is to say, in the embodiments of the present disclosure, the data to be processed is subjected to multi-task processing. Taking images as an example, processing tasks can include image recognition, image reconstruction, etc. The embodiments of the present disclosure do not limit the processing tasks corresponding to the data to be processed.

In an embodiment, the terminal device sends the collected data to be processed to the edge for processing via a local area network or other means, where the edge processes the data to obtain intermediate features, compresses the intermediate features to obtain intermediate compressed features, and then sends the intermediate compressed features to the cloud for subsequent processing. The cloud decompresses the intermediate compressed features to obtain the corresponding intermediate features, and then processes the intermediate features according to different processing tasks to obtain cloud decoding results corresponding to different processing tasks. Additionally, the task processing in the cloud is a multi-task processing procedure, with each processing task corresponding to a cloud decoder, thus the intermediate features are input into different cloud decoders for processing.

Herein, an edge encoder, at least one lightweight edge decoder corresponding to different processing tasks, and an edge compression model are deployed on the edge, while a cloud decompression model and a cloud decoder are deployed on the cloud server.

In an embodiment, after segmenting the cloud-edge collaborative processing model, the edge encoder and the cloud decoder are obtained, where the edge encoder is deployed on the edge, and the cloud decoder is deployed in the cloud. The embodiments of the present disclosure do not impose specific limitations on the segmentation point, meaning that the cloud-edge collaborative processing model can be segmented into two parts using any segmentation method, with the part to be deployed on the edge referred to as the edge encoder, and the part to be deployed on the cloud referred to as the cloud decoder. In specific applications, the cloud-edge collaborative processing model is segmented, and then the lightweight edge decoder and the edge compression model are added behind the segmented edge encoder, jointly deployed on the edge. The cloud decompression model is added in front of the segmented cloud decoder, and jointly deployed in the cloud.

In an embodiment, a suitable segmentation point may also be determined based on the computing power of the edge and the cloud, such that the resulted computational load of the edge encoder is less than that of the cloud decoder according to the determined segmentation point.

Since the edge compression model and the cloud decompression model are set, the embodiments of the present disclosure do not need to consider whether the data dimension of the intermediate features is less than that of the data to be processed when determining the segmentation point, thus expanding the range of the segmentation point, making it adaptable to different cloud-edge collaborative processing models.

In another embodiment of the present disclosure, compression rates of different models are controlled in the cloud-edge collaborative data processing system, further reducing the amount of data to be processed and reducing communication overhead.

The cloud-edge collaborative data processing method according to an embodiment of the present disclosure will be described below in conjunction with the above figures.

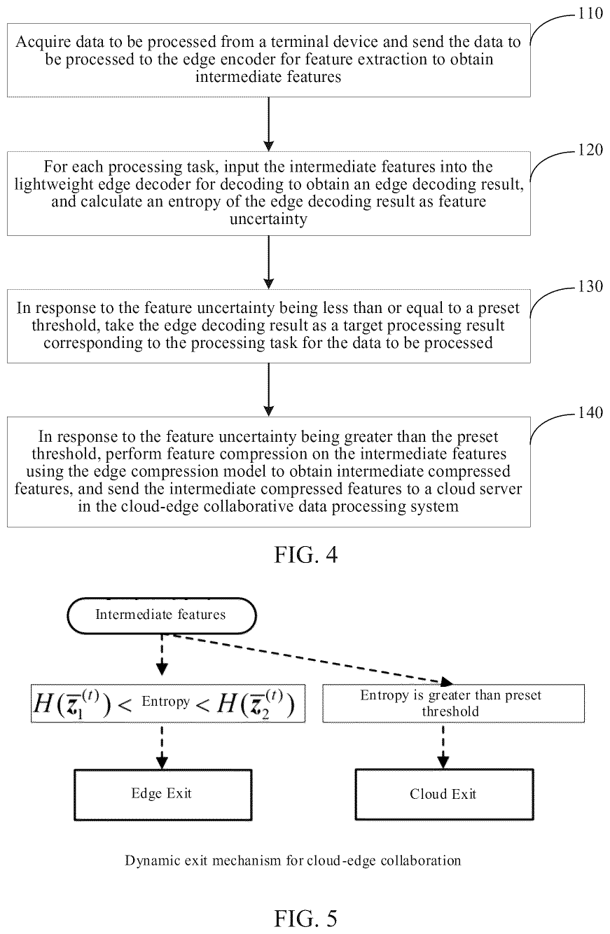

FIG. 4 is an alternative flowchart illustrating the application of a cloud-edge collaborative data processing method to an edge server, according to an embodiment of the present disclosure. The method in FIG. 4 may include, but is not limited to, steps 110 to 140. Meanwhile, it can be understood that this embodiment does not impose specific limitations on the order of steps 110 to 140 in FIG. 4, and the order of steps may be adjusted or certain steps may be deleted or added based on actual needs.

At Step 110, data to be processed is acquired from a terminal device and then sent to an edge encoder for feature extraction to obtain an intermediate feature.

In an embodiment, with reference to FIG. 3, at the edge, the edge encoder is employed to extract features from the data to be processed, transform the features to be processed into more compact and information-rich intermediate features, thereby reducing the data dimension through feature extraction. Only key features are extracted for possible subsequent cloud computations, which can significantly reduce the bandwidth requirement for data transmission, allowing the cloud to avoid processing large amounts of raw data and enabling faster decision-making and response.

At Step 120, for each processing task, the intermediate features are input into a lightweight edge decoder for decoding to obtain an edge decoding result, and an entropy of the edge decoding result is calculated as feature uncertainty.
the computational complexities of various processing tasks vary, and there are differences in computing power between the cloud and the edge. The cloud possesses powerful computing capabilities and large storage capacity, suitable for handling tasks with complex analysis and large data storage; while the edge has lower processing latency, suitable for rapid response and processing of real-time data. If all processing tasks are executed in the cloud, it not only results in the underutilization of the computing power of the edge but also compromises overall processing efficiency. Therefore, in embodiments of the present disclosure, a selection is made regarding the processing tasks of the intermediate features, determining which processing tasks are executed by the cloud and which are executed by the edge, thus rationally allocating processing tasks between the cloud and the edge, optimizing the computing power consumption during the cloud-edge collaboration process and maximizing overall budget efficiency.

In an embodiment, a lightweight edge decoder consistent with the cloud decoder on the cloud is deployed at the edge, that is, there is a corresponding lightweight edge decoder for each cloud decoder. The processing tasks for the lightweight edge decoder are the same as that of the cloud decoder, but the model structure of the lightweight edge decoder is more lightweight, offering higher processing efficiency and faster response speed.

For the t-th processing task, the t-th cloud decoder is denoted as C^{(t)}(\tilde{y}; θ^{(t)}), where \tilde{y} represents intermediate features after cloud decompression, and θ(t) represents model parameters of the cloud decoder. The corresponding t-th lightweight edge decoder is denoted as C̅^{(t)}(y; η^{(t)}), y representing intermediate features at the edge, and η(t) representing model parameters of the lightweight edge decoder, where the parameter size of η(t) is smaller than the parameter size of θ^{(t)}.

First, the intermediate features are input into the lightweight edge decoder for decoding to obtain an edge decoding result z̅(t), and then, an entropy H(z̅^{(t)}) of the edge decoding result z̅^{(t)} is calculated as a feature uncertainty, where H(⋅) represents an entropy calculation function, such as Shannon entropy. The purpose of calculating the entropy in this embodiment of the present disclosure is to obtain the uncertainty of the edge decoding result to measure the information quantity, such that intermediate features with less information quantity are kept at the edge for processing, while intermediate features with more information quantity are sent to the cloud, utilizing the cloud decoder with a stronger expressive capability to extract information.

At Step 130, in response to the feature uncertainty being less than or equal to a preset threshold, the edge decoding result is taken as a target processing result corresponding to the processing task for the data to be processed.

In an embodiment, different processing tasks correspond to different preset thresholds. FIG. is a schematic diagram of a dynamic exit mechanism for cloud-edge collaboration according to an embodiment of the present disclosure. The dynamic exit mechanism for cloud-edge collaboration includes Edge Exit and Cloud Exit. Edge Exit refers to the entire processing flow ending at the edge, while Cloud Exit refers to the entire processing flow ending at the cloud, reducing the number of communication rounds with the cloud.

For Edge Exit: after obtaining the entropy H(z̅^{(t)}) corresponding to the edge decoding result z̅^{(t)} from the intermediate features, this entropy H(z̅^{(t)}) is compared with the preset threshold. Assume the preset threshold corresponding to the t-th processing task is [H(z̅₁^{(t)}), H(z̅₂^{(t)})]. In this case, if the following condition is satisfied: H(z̅₁^{(t)})≤H(z̅^{(t)})≤H(z̅₂^{(t)}), then a result of Edge Exit is received, meaning that the edge decoding result z̅^{(t)} is taken as the target processing result corresponding to the t-th processing task.

At Step 140, in response to the feature uncertainty being greater than the preset threshold, feature compression on the intermediate features is performed by using the edge compression model to obtain intermediate compressed features, and the intermediate compressed features are sent to a cloud server in the cloud-edge collaborative data processing system.

With reference to FIG. 3, a cloud decompression model and cloud decoders corresponding to various processing tasks are deployed on the cloud server. In an embodiment, the cloud decompression model is configured to decompress the intermediate compressed features to obtain intermediate decompressed features, and the cloud decoder is configured to decode the intermediate decompressed features to obtain a cloud decoding result, which is then taken as the target processing result corresponding to the processing task.

Referring to FIG. 5, if the condition for Edge Exit is not satisfied, meaning that the feature uncertainty is greater than the preset threshold, the process proceeds to Cloud Exit. The edge compression model is utilized to compress the intermediate features to obtain intermediate compressed features, which are then sent to the cloud server in the cloud-edge collaborative data processing system, where the data is processed in the cloud by the cloud decoder corresponding to the t-th processing task for decoding, yielding the corresponding cloud decoding result as the target processing result.

The above dynamic exit mechanism for cloud-edge collaboration can also respond to network fluctuations. Although the accuracy of the lightweight edge decoder is not as good as that of the cloud decoder, when providing qualified data that meets the requirements of the processing task, the processing flow can also exit at the edge. When a more accurate result is needed, the processing flow exits at the cloud, thus meeting the dual requirements of speed and accuracy.

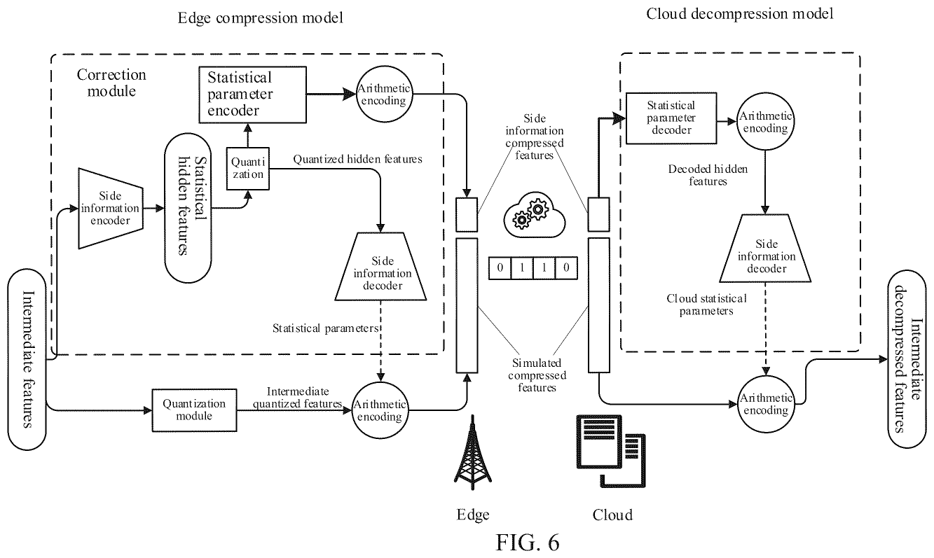

Next, refer to FIG. 6. FIG. 6 is a flowchart illustrating the process of a cloud-edge collaborative data processing method according to an embodiment of the present disclosure. As can be seen from FIG. 6, the edge compression model includes at least a quantization model or a correction model, where the correction model includes a side information encoder, a statistical parameter encoder, and a side information decoder. The purpose of the correction model in this embodiment is to increase the information quantity of the intermediate features, adjusting their distribution, such that different intermediate features have different distribution characteristics, thereby improving the accuracy of data processing results. Therefore, the correction model is determined whether to be added based on actual requirements and the actual computing power of the edge.

In an embodiment, taking a separate quantization model as an example, the process of using the edge compression model to perform feature compression on the intermediate features to obtain the intermediate compressed features specifically includes: quantizing the intermediate features using the quantization model to obtain intermediate quantized features, and performing arithmetic encoding on the intermediate quantized features to obtain the intermediate compressed features in the form of a binary string.

In an embodiment, during the model training process, the quantization process employed may be a soft quantization process, which utilizes a uniform distribution for soft quantization, adding an error term to the intermediate features y′ to obtain intermediate quantized features ŷ, expressed as: ŷ=y′+ϵ, where ϵ˜U(−0.5, 0.5). During the model inference process, a rounding-based hard quantization operation is employed to obtain intermediate quantized features ŷ, expressed as: ŷ=\hat{Q}(y), where \hat{Q} represents the rounding operation.

In an embodiment, the arithmetic encoding is subsequently performed on the intermediate quantized features, compressing the intermediate quantized features using default statistical distribution parameters, where the default statistical distribution parameters include mean, standard deviation, and the like. In this embodiment, the principle of arithmetic encoding is: long bytes are intended to represent numbers with low occurrence probabilities in the intermediate quantized features, while short bytes are intended to represent numbers with high occurrence probabilities in the intermediate quantized features. Therefore, it is necessary to obtain the occurrence probabilities of each number in the intermediate quantized features based on the statistical distribution parameters. After arithmetic encoding, intermediate compressed features composed of a binary string are obtained.

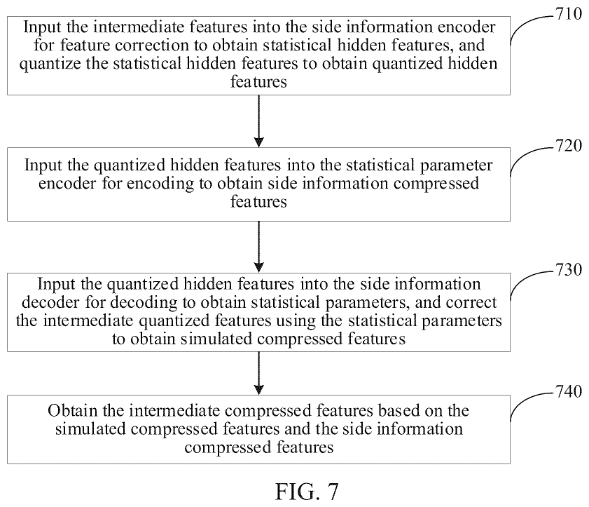

In an embodiment, taking the edge compression model further including the correction model as an example, the purpose of the correction model is to provide self-adaptive statistical parameters for the intermediate quantized features that differ from the default statistical distribution parameters. Please refer to FIG. 7. FIG. 7 is a schematic diagram illustrating feature compression of intermediate features using an edge compression model to obtain intermediate compressed features according to an embodiment of the present disclosure, specifically including the following steps S710 to S740.

At Step 710: the intermediate features are input into the side information encoder for feature correction to obtain statistical hidden features, and the statistical hidden features are quantized to obtain quantized hidden features.

In an embodiment, with reference to FIG. 6, the side information encoder deployed at the edge is configured to mine hidden features corresponding to true statistical parameters of intermediate features. For example, the true statistical parameters may be true means or true standard deviations, etc. The statistical hidden features can reflect the distribution of different intermediate features. Subsequently, after obtaining the statistical hidden features, the statistical hidden features are quantized to obtain quantized hidden features. It can be understood that, referring to the aforementioned quantization process of the intermediate features, soft quantization may be adopted during the training phase, while hard quantization may be adopted during the inference phase. This embodiment does not impose restrictions on this.

At Step 720: the quantized hidden features are input into the statistical parameter encoder for encoding to obtain side information compressed features.

In an embodiment, after obtaining the quantized hidden features, two parts of processing are required. The first part involves using the quantized hidden features to adapt the statistical parameters for the compression process of the intermediate quantized features, while the other part involves compressing the quantized hidden features and transmitting them to the cloud to decode the intermediate compressed features obtained through statistical parameter adaptation.

In an embodiment, the quantized hidden features are input into the statistical parameter encoder for arithmetic encoding to obtain side information compressed features. The purpose of the statistical parameter encoder here is to compress the quantized hidden features through arithmetic encoding. By inputting a set of quantized hidden features, the corresponding side information compressed features can be output.

At Step 730: the quantized hidden features are input into the side information decoder for decoding to obtain statistical parameters, and the intermediate quantized features are corrected by using the statistical parameters to obtain simulated compressed features.

In an embodiment, information is mined from the quantized hidden features to obtain statistical parameters that can represent the true statistical parameters of the intermediate features. In an implementation, the quantized hidden features are input into the side information decoder for decoding, and thus the corresponding statistical parameters can be obtained.

When performing arithmetic encoding on the intermediate quantized features subsequently, unlike the previous approach of compressing the intermediate quantized features using default statistical distribution parameters, the obtained statistical parameters are utilized at this time to correct the intermediate quantized features, thereby generating simulated compressed features. Due to the use of true statistical parameters, it is possible to correct the probability of occurrence of each symbol to be encoded during lossless entropy encoding, enabling the simulated compressed features to approach the Shannon limit as closely as possible.

At Step 740: the intermediate compressed features are obtained based on the simulated compressed features and the side information compressed features.

In an embodiment, the obtained simulated compressed features and side information compressed features are concatenated to obtain the overall intermediate compressed features, which are then sent to the cloud for subsequent processing. By correcting the compression process, the compression rate of the intermediate features and the accuracy of subsequent processing tasks are further improved.

In an embodiment, to self-adaptively adjust the compression rate at the edge, different delta values are set during the training process to obtain different relevant models. Due to the differences in delta values, the output results of the obtained models will also vary, reflected in the final intermediate compressed features having different compression rates. Therefore, model training can be conducted in advance based on different delta values to obtain relevant models corresponding to different compression rates.

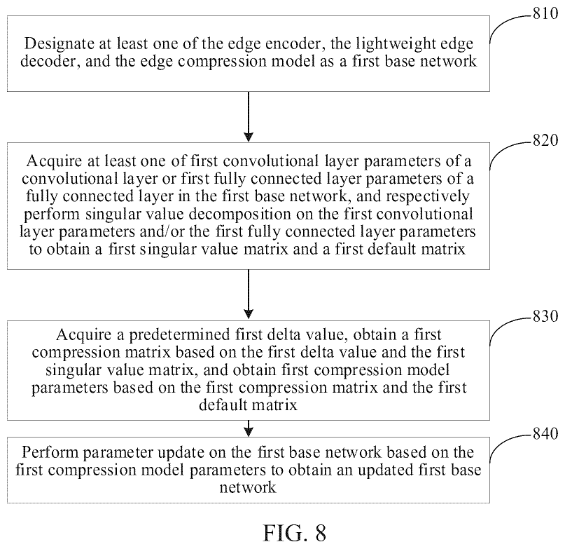

Please refer to FIG. 8. FIG. 8 is a flowchart illustrating self-adaptive adjustment of a compression rate at the edge according to an embodiment of the present disclosure, specifically including the following steps S810 and S820.

At Step 810: at least one of the edge encoder, the lightweight edge decoder, and the edge compression model is taken as a first base network.

In an embodiment, for the edge encoder, lightweight edge decoder, and edge compression model at the edge, the self-adaptive adjustment of the compression rate can be performed in this method. It is understandable that the compression rate control processes for the edge encoder, lightweight edge decoder, and edge compression model are independent. Therefore, one or more first base networks can be selected based on actual requirements.

At Step 820: at least one of first convolutional layer parameters of a convolutional layer or first fully connected layer parameters of a fully connected layer in the first base network are acquired, and singular value decomposition on the first convolutional layer parameters and/or the first fully connected layer parameters is/are respectively perform to obtain a first singular value matrix and a first default matrix.

In an embodiment, the first base network is a neural network, and parameters within the convolution layer or fully connected layer can be locked, thus obtaining different training results. Therefore, at least one of the first convolution layer parameters of the convolution layer or the first fully connected layer parameters of the fully connected layer in the first base network is selected as the relevant parameters to be locked, and then singular value decomposition is performed on the selected first convolution layer parameters and/or the first fully connected layer parameters to obtain the first singular value matrix and the first default matrix.

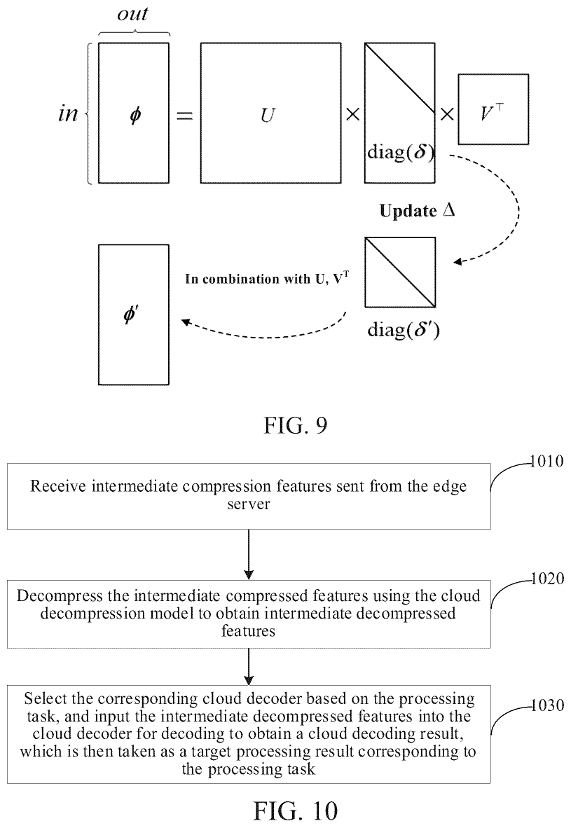

Please refer to FIG. 9. FIG. 9 is a schematic diagram illustrating adjustment of a compression rate of a first base network according to an embodiment of the present disclosure. The first convolution layer parameters or the first fully connected layer parameters are selected as adjustment parameters ϕ∈R^{in×out}, the input data dimension is in, and the output data dimension is out. Singular value decomposition is performed on the adjustment parameters ϕ, which is represented as:

$$ϕ = U \times diag ( δ ) \times {V}^{T}$$

where U is an in×in unitary matrix, V is an out×out unitary matrix, diag(δ) is a semi-definite in×out diagonal matrix, the two unitary matrices U and V are taken as the first default matrix, and δ is taken as the first singular value matrix.

At Step 830: a predetermined first delta value is acquired, a first compression matrix is obtained based on the first delta value and the first singular value matrix, and first compression model parameters are obtained based on the first compression matrix and the first default matrix.

In an embodiment, the model parameters are updated according to the actual training process, the parameter changes of the model are quantified to obtain at least one first delta value Δ and then obtain the first compression matrix, which is represented as: δ′=ReLU (δ+Δ), based on the first delta value Δ and the first singular value matrix δ, where ReLU is the activation function. Finally, the first compression model parameters ϕ′ are obtained based on the first compression matrix and the first default matrix, expressed as:

$${ϕ}^{′} = U \times diag ( {δ}^{′} ) \times {V}^{T}$$

At Step 840: parameter update is performed on the first base network based on the first compression model parameters to obtain an updated first base network.

In an embodiment, parameter updates are performed on the first base network using different first compression model parameters to obtain a correspondingly different, updated first base network. It can be understood that by decomposing the parameter space of the model, the delta values and the updated first base networks are correlatively stored, and when storing the relevant models corresponding to the different compression rates of intermediate features, only the first basic model and a small amount of update parameters corresponding to the compression rate need to be stored, thereby achieving flexible adjustment of the compression rate while saving storage resources at the edge. Meanwhile, when selecting the delta values to switch between the compression rates according to actual needs, the original first base network is replaced with the updated first base network, thereby controllably adjusting the compression rate of the intermediate compressed features.

In the embodiments of the present disclosure, the cloud-edge collaborative data processing model is segmented, with one part of the processing occurring at the edge and the other part occurring at the cloud. Through this segmented processing, the data to be processed is transformed into intermediate features of smaller dimensions, and then these intermediate features are compressed to further reduce the amount of data sent from the edge to the cloud, thereby reducing communication overhead. In addition, for different processing tasks, a lightweight model is employed first to calculate a quick result, and based on the entropy of that result, it is determined whether to select the processing result from the edge or the processing result from the cloud. This dynamic exit mechanism for flexible cloud-edge collaboration selectively compresses part of the data from the full dataset for transmission, which can further reduce the data volume and communication overhead.

The following describes a cloud-edge processing procedure of a cloud-edge collaborative data processing method according to an embodiment of the present disclosure.

FIG. 10 is a flowchart illustrating a cloud-edge collaborative data processing method applied to a cloud server according to an embodiment of the present disclosure. The method in FIG. 10 may include, but is not limited to, steps 1010 to 1030. Meanwhile, it can be understood that this embodiment does not impose specific limitations on the order of steps 1010 to 1030 in FIG. 10, and the order of steps may be adjusted or certain steps may be deleted or added based on actual needs.

At Step 1010: intermediate compressed features sent from the edge server are received.

At Step 1020: the intermediate compressed features are decompressed by using the cloud decompression model to obtain intermediate decompressed features.

In an embodiment, with reference to FIG. 4, the cloud utilizes the cloud decompression model to perform a decompression operation corresponding to the compression on the intermediate compressed features, obtaining the intermediate decompressed features.

In an embodiment, since the intermediate compressed features may include the result of the correction module, the decompression operation should also be divided into two parts. If the intermediate compressed features do not include the side information compressed features provided by the correction module, inverse arithmetic decoding is directly performed on the intermediate compressed features based on the default statistical distribution parameters to obtain the intermediate decompressed features. It can be understood that if transmission losses and decoding errors are ignored, the intermediate decompressed features are consistent with the intermediate features.

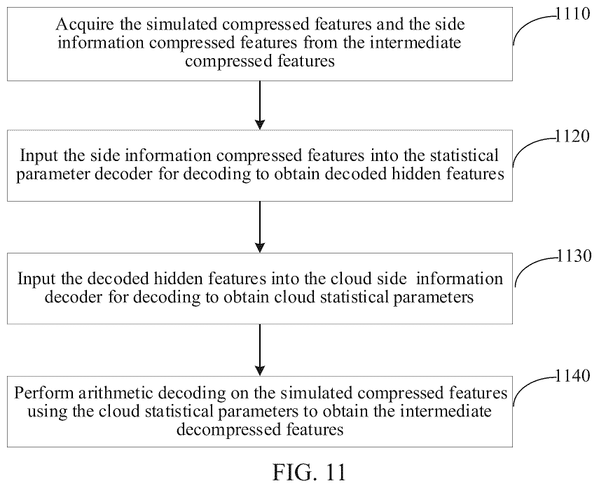

In an embodiment, if the intermediate compressed features contain side information compressed features provided by the correction module, decompression based on the side information compressed features is required. With reference to FIG. 6, in this case, the cloud decompression model includes the corresponding cloud side information decoder and statistical parameter decoder. Please refer to FIG. 11. FIG. 11 is a flowchart illustrating decompression of intermediate compressed features using a cloud decompression model to obtain intermediate decompressed features, specifically including the following steps 1110-1140:

At Step 1110: the simulated compressed features and the side information compressed features are acquired from the intermediate compressed features.

In an embodiment, since the simulated compressed features and side information compressed features are obtained through concatenation, the cloud can directly extract the corresponding simulated compressed features and side information compressed features from the received intermediate compressed features.

At Step 1120: the side information compressed features are input into the statistical parameter decoder for decoding to obtain decoded hidden features.

In an embodiment, the statistical parameter decoder has a functionality opposite to that of the statistical parameter encoder. The side information compressed features are input into the statistical parameter decoder for decoding, and then the decoded hidden features are obtained. It can be understood that the decoded hidden features are the quantized hidden features obtained from decoding. The inconsistency in their names is intended for differentiation, while also reflecting the errors introduced during transmission, encoding, and decoding processes.

At Step 1130: the decoded hidden features are input into the cloud side information decoder for decoding to obtain cloud statistical parameters.

In an embodiment, after obtaining the decoded hidden features, similar to step 730, the decoded hidden features are input into the cloud side information side information decoder for decoding to obtain the cloud statistical parameters. It can be understood that the cloud side information decoder on the cloud and the side information decoder at the edge can also share parameters to reduce training costs.

At Step 1140: arithmetic decoding is performed on the simulated compressed features using the cloud statistical parameters to obtain the intermediate decompressed features.

In an embodiment, since the process of arithmetic encoding determines the byte length used for different numbers in the simulated compressed features based on statistical parameters, the inverse arithmetic decoding process can determine the possible numbers corresponding to long and short bytes according to the simulated compression parameters related to the statistical parameters, thereby completing the decoding process and obtaining the intermediate decompressed features.

At Step 1030: the corresponding cloud decoder is selected based on the processing task, and the intermediate decompressed features are input into the cloud decoder for decoding to obtain a cloud decoding result, which is then taken as a target processing result corresponding to the processing task.

The exit timing for different processing tasks varies. if it is an Edge Exit, there is no need to perform the decoding process for that processing task on the cloud. Therefore, some processing tasks exit at the edge while others exit at the cloud. In this case, task identifiers can be added during the transmission of intermediate compressed features, allowing the cloud to know which processing tasks need to be executed and thus select the corresponding cloud decoders. After selecting the corresponding cloud decoders, the intermediate decompressed features are input into the cloud decoders for decoding to obtain the cloud decoding results, in which case, these processing tasks are all Cloud Exit, so the corresponding cloud decoding results are taken as the target processing results for the processing tasks.

In an embodiment, referring to the compression rate control process at the edge, the cloud may also perform compression rate control on the relevant models. The specific process includes the following steps: designating at least one of the cloud decompression model or the cloud decoder as a second base network; acquiring at least one of second convolutional layer parameters of a convolutional layer or second fully connected layer parameters of a fully connected layer in the second base network, and performing singular value decomposition on the second convolutional layer parameters and/or the second fully connected layer parameters respectively to obtain a second singular value matrix and a second default matrix; acquiring a predetermined second delta value, obtaining a second compression matrix based on the second delta value and the second singular value matrix, and obtaining second compression model parameters based on the second compression matrix and the second default matrix; and performing parameter update on the second base network based on the second compression model parameters to obtain an updated second base network.

With reference to the descriptions of the above embodiments, in the cloud-edge collaborative data processing system according to the embodiments of the present disclosure, the edge server is configured to perform feature extraction using the edge encoder on the data to be processed from a terminal device to obtain intermediate features, decode, using the lightweight edge decoder, the intermediate features input thereto to obtain an edge decoding result, calculate an entropy of the edge decoding result as feature uncertainty, and take the edge decoding result as a target processing result for the data to be processed in response to the feature uncertainty being less than or equal to a preset threshold, or perform feature compression on the intermediate features using the edge compression model to obtain intermediate compressed features in response to the feature uncertainty being greater than the preset threshold, and send the intermediate compressed features to the cloud server.

The cloud server is configured to decompress the intermediate compressed features using the cloud decompression model to obtain intermediate decompressed features, select the corresponding cloud decoder based on the processing task, and input the intermediate decompressed features into the cloud decoder for decoding to obtain a cloud decoding result, which is then taken as a target processing result corresponding to the processing task.

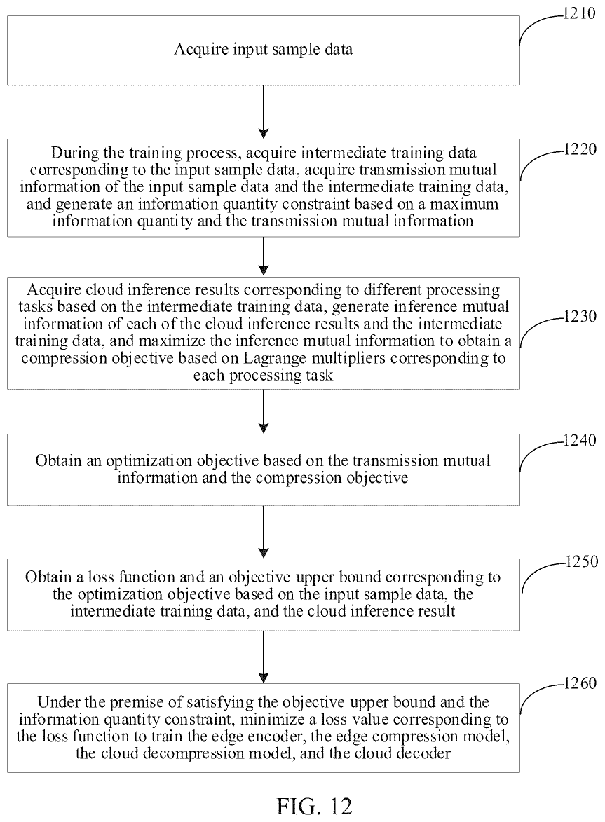

FIG. 12 is a flowchart illustrating a training process of an edge encoder, an edge compression model, a cloud decompression model, and a cloud decoder in a cloud-edge collaborative data processing system according to an embodiment of the present disclosure. In an embodiment, the process specifically includes the following steps 1210 to 1260.

At Step 1210: input sample data is acquired.

In an embodiment, the training process of the model is performed using information theory, so only input sample data similar to the data to be processed needs to be acquired.

At Step 1220: During the training process, intermediate training data corresponding to the input sample data are acquired, transmission mutual information of the input sample data and the intermediate training data is acquired, and an information quantity constraint is generated based on a maximum information quantity and the transmission mutual information.

At Step 1230: cloud inference results corresponding to different processing tasks are generated based on the intermediate training data, inference mutual information of each of the cloud inference results and the intermediate training data is generated, and the inference mutual information is maximized to obtain a compression objective based on Lagrange multipliers corresponding to each processing task.

In an embodiment, it is assumed that the input sample data is represented as x, the intermediate training data is represented as y, and the cloud inference result obtained from the t-th processing task is represented as z^{(t)}, with the total number of processing tasks being T. In this case, the joint distribution of T types of processing tasks in the entire cloud-edge collaborative data processing process is expressed as:

$$p ( x , y , {z}^{( 1 : T )} ) = p ( x , y , {z}^{( 1 )} , {z}^{( 2 )} , … , {z}^{( T )} )$$

where p(⋅) is a probability density function.

Since the intermediate training data is a hidden representation of the input sample data, when x is given, y cannot provide additional information to z^{(t)}. This process is modeled using mutual information as I(y; z^{(t)}|x)=0, where I(⋅) is a mutual information calculation function.

Since mutual information is a measure of the interdependence between two random variables, this modeling process indicates that the mutual information between the intermediate training data y and the cloud inference result corresponding to any processing task (taking task/as an example) is zero under the condition of given input sample data x. It is also equivalent to the three satisfying the Markov chain: z^{(t)}↔x↔y, where y and z^{(t)} are independent of each other with a given x.

Next, the transmission mutual information of the input sample data and intermediate training data is obtained, expressed as: I(x; y), where the transmission mutual information is intended to measure the degree of information sharing between the input sample data and the intermediate training data. Meanwhile, since the objective of the embodiments of the present disclosure is to reduce the communication overhead in the cloud-edge communication, it is necessary to limit the maximum information quantity I_{c} flowing from x into y, which is modeled as a maximum information quantity and transmission mutual information generating an information quantity constraint, which is expressed as: I(x; y)≤I_{c}.

Next, to ensure that the cloud decoder can obtain the correct cloud inference result z^{(t)}, the most effective information needs to be retained in y. First, the inference mutual information I(y; z^{(t)}) between the cloud inference result and the intermediate training data is obtained, and then the inference mutual information is maximized. This process is modeled as

$$max {\sum }_{t = 1}^{T} I ( y ; {z}^{( t )} ) .$$

In an embodiment, considering that different processing tasks have different weights on the cloud, a Lagrange multiplier β^{(t)} is assigned to each processing task, where β^{(t)}>0 to ensure that the information contribution of each processing task is taken into account.

Then, based on the Lagrange multipliers, the compression objective obtained by maximizing the inference mutual information is expressed as:

$$max {\sum }_{t = 1}^{T} I ( y ; {z}^{( t )} ) s . t . I ( x ; y ) \leq {I}_{c} .$$

At Step 1240: an optimization objective is obtained based on the transmission mutual information and the compression objective.

In an embodiment, the optimization objective is expressed as:

$$J = I ( x ; y ) - {\sum }_{t = 1}^{T} {β}^{( t )} I ( y ; {z}^{( t )} ) , {β}^{( t )} > 0$$

At Step 1250: a loss function and an objective upper bound corresponding to the optimization objective are obtained based on the input sample data, the intermediate training data, and the cloud inference result.

In an embodiment, the process of converting input sample data into intermediate training data at the edge is modeled as p(y|x), where p(⋅|⋅) is a conditional probability density function, and the process of converting intermediate training data into the cloud inference result of the t-th processing task at the cloud is modeled as p(z^{(t)}|y). Then, based on experimental prior knowledge, probability distributions r(y) and q(z^{(t)}|y) are employed to approximate p(y) and p(z^{(t)}|y), respectively. The objective upper bound corresponding to the optimization objective is expressed as:

$$J \leq - {\sum }_{t = 1}^{T} {β}^{( t )} \int \int \int p ( x , {z}^{( t )} ) p ( y \vert x ) log q ( {z}^{( t )} \vert y ) {dxdydz}^{( t )} + \int \int p ( x ) p ( y \vert x ) log \frac{p ( y \vert x )}{r ( y )} dxdy$$

where the objective upper bound consists of two integral terms. The preceding integral term represents the joint distribution of input sample data, intermediate training data, and cloud inference results, as well as the approximate conditional distribution q(z^{(t)}|y), while the subsequent integral term represents the relationship between the distributions of input sample data, intermediate training data, and the approximate distribution r(y).

At Step 1260: Under the premise of satisfying the objective upper bound and the information quantity constraint, a loss value corresponding to the loss function is minimized, and the edge encoder, the edge compression model, the cloud decompression model, and the cloud decoder are trained.

In an embodiment, with the objective upper bound and information quantity constraint, the model parameters can be adjusted to minimize the loss value corresponding to the loss function without exceeding the objective upper bound and while satisfying the information quantity constraint. Herein, the loss function of T processing tasks is expressed as:

$$L = {𝔼}_{p ( x )} {𝔼}_{p ( \tilde{y} \vert x )} [ log p ( \tilde{y} \vert x ) - log r ( \tilde{y} ) ] - {\sum }_{t = 1}^{T} {𝔼}_{p ( x , {z}^{( t )} )} [ {β}^{( t )} log q ( {z}^{( t )} \vert \tilde{y} ) ]$$

where r(⋅) and q(⋅) are probability density functions, ψ is the parameters of r(y), \tilde{y} is the quantization result corresponding to the intermediate training data, [symbol] ₚ₍ₓ₎[⋅] represents the expectation under the probability distribution p(x). The first part of the aforementioned loss function is the expected log-likelihood term for ensuring that the quantization result can be effectively generated from the input sample data, and the second part thereof is for ensuring that the cloud inference result of each processing task can be accurately predicted from the quantization result.

In an embodiment, the processing procedure at the edge is modeled as:

$$p ( \tilde{y} \vert x ; {ϕ}_{e} ) = {\prod }_{i} U ( {\tilde{y}}^{( i )} \vert {y}^{( i )} - 0.5 , {y}^{( i )} + 0.5 ) ,$$

$$y = E ( x ; {ϕ}_{e} ) .$$

where, E(x; ϕₑ) is an edge encoder with edge parameters ϕₑ for mapping high-dimensional data to a latent space y and obtaining \tilde{y} by performing quantization on each corresponding element i.

In an embodiment, the processing procedure at the cloud is modeled as:
the classification task:

$$q ( {z}^{( t )} \vert \tilde{y} ; {θ}^{( t )} ) = {\prod }_{j = 1}^{K} {( \frac{exp ( {c}_{j} )}{{\sum }_{i = 1}^{K} exp ( {c}_{i} )} )}^{{z}_{j}^{( t )}}$$

$$[ {c}_{1} , … , {c}_{K} ] = {C}^{( t )} ( \tilde{y} ; {θ}^{( t )} ) , {z}_{j}^{( t )} = {I}_{cls ( j )} ( {z}^{( t )} )$$

the reconstruction task:

$$q ( {z}^{( t )} \vert \tilde{y} ; {θ}^{( t )} ) = N ( {z}^{( t )} \vert {C}^{( t )} ( \tilde{y} ; {θ}^{( t )} ) , 1 ) .$$

Herein, C^{(t)}(\tilde{y}; θ^{(t)}) is a cloud decoder with parameters θ^{(t)}, I_{cls} is a 0-1 indicator function for category j, and N is a normal distribution.

As can be seen from the aforementioned training process, the compression process of the edge compression module in the embodiment of the present disclosure is related to the training results of the edge encoder. The training objective is obtained through probability modeling in information theory to compress the most useful data. For example, in the task of image classification, the background of the image is irrelevant information, while the objects are useful information. Therefore, through the training process, the edge compression module, in combination with the edge encoder, removes irrelevant information as much as possible to achieve maximum compression effect. Moreover, with this end-to-end training approach under a unified framework, the cloud-edge collaborative data processing system can automatically learn the most suitable feature representations and compression strategies for specific tasks while maintaining high efficiency.

The cloud-edge collaborative data processing method in the embodiments of the present disclosure transforms intermediate features into compression-friendly data through joint optimization, directly compresses and transmits the intermediate features to the cloud via lossless entropy encoding after quantization, and then the cloud decoder performs inference based on these intermediate features to obtain the final result. During the compression of intermediate features, the most effective information is retained, saving bandwidth resources for communication between the edge and the cloud while reducing inference latency.

The experimental verification results of the cloud-edge collaborative data processing method in the embodiments of the present disclosure are described below.

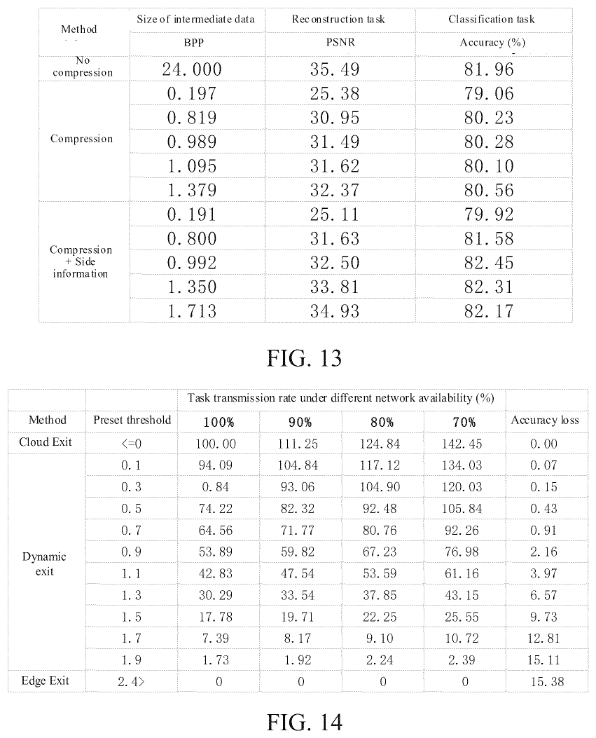

Please refer to FIG. 13. FIG. 13 shows experimental results of accuracy with image classification and reconstruction tasks according to an embodiment of the present disclosure. This embodiment of the present disclosure takes the Imagenette dataset as an example to conduct relevant experiments on image classification and reconstruction tasks. The experimental data shows that the data size of intermediate data with no compression is the largest. According to the experimental results, with acceptable task result loss, the process with compression of intermediate features saves significant communication overhead compared to the process with no compression, and the compression process with additional side information achieves greater compression degree than the compression process without side information.

Please refer to FIG. 14. FIG. 14 shows the accuracy loss with a dynamic exit mechanism for cloud-edge collaboration under different network availability according to an embodiment of the present disclosure. In this embodiment, the accuracy loss of the dynamic exit mechanism for cloud-edge collaboration is verified under different network availability rates, such as 100%, 90%, 80%, and 70%. The dataset remains the Imagenette dataset, taking a classification task as an example to verify the task success rate during further cloud-edge inference. Since the classification accuracy of the lightweight edge decoder deployed at the edge is 15.38% lower than ta decoder of the cloud, the dynamic exit mechanism for cloud-edge collaboration allows data that is easier to process at the edge to remain as the Edge Exit, while only more challenging data is compressed and sent to the cloud. Experimental results show that the communication overhead is reduced within an acceptable overall task accuracy loss.

According to the technical schemes provided by the embodiment of the present disclosure, data to be processed is acquired from a terminal device and the data to be processed is sent to the edge encoder for feature extraction to obtain intermediate features. Next, for each processing task, the intermediate features are input into the lightweight edge decoder for decoding to obtain an edge decoding result, and an entropy of the edge decoding result is calculated as feature uncertainty. In response to the feature uncertainty being less than or equal to a preset threshold, the edge decoding result is taken as a target processing result corresponding to the processing task for the data to be processed, or in response to the feature uncertainty being greater than the preset threshold, a feature compression is performed on the intermediate features using the edge compression model to obtain intermediate compressed features, and the intermediate compressed features are sent to a cloud server in the cloud-edge collaborative data processing system. The intermediate compressed features are decompressed on the cloud server to obtain intermediate decompressed features, and the intermediate decompressed features are decoded to obtain a cloud decoding result, which is taken as the target processing result corresponding to the processing task. In the embodiments of the present disclosure, the cloud-edge collaborative data processing model is segmented, with one part of the processing occurring at the edge and the other part occurring at the cloud. Through this segmented processing, the data to be processed is transformed into intermediate features of smaller dimensions, and then these intermediate features are compressed to further reduce the amount of data sent from the edge to the cloud, thereby reducing communication overhead. In addition, for different processing tasks, a lightweight model is utilized first to calculate a quick result, and based on the entropy of that result, it is determined whether to select the processing result from the edge or the processing result from the cloud. This flexible dynamic exit mechanism for cloud-edge collaboration selectively compresses part of the data from the full dataset for transmission, which can further reduce the data volume and communication overhead.

A further embodiment of the present disclosure provides an electronic device, including:
at least one memory;
at least one processor; and
at least one program, where
the at least one program is stored in the at least one memory, and the at least one program, when executed by the at least one processor, causes the at least one processor to implement the above-described cloud-edge collaborative data processing method. The electronic device may be any intelligent terminal device such as a mobile phone, a tablet computer, a personal digital assistant (PDA), and a vehicle-mounted computer.

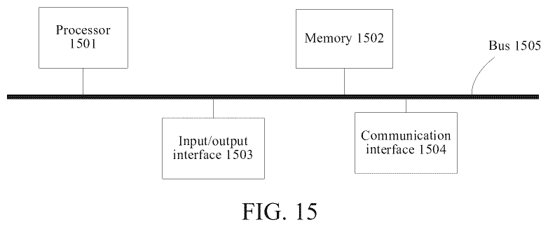

Refer to FIG. 15. FIG. 15 illustrates the hardware structure of an electronic device according to another embodiment of the present disclosure. The electronic device includes:
a processor 1501, which may be implemented by a general-purpose central processing unit (CPU), a microprocessor, an application-specific integrated circuit (ASIC), or one or more integrated circuits, for executing related programs to implement the technical schemes provided by the embodiments of the present disclosure; and
a memory 1502, which may be implemented in forms such as read-only memory (ROM), static storage devices, dynamic storage devices, or random access memory (RAM), where the memory 1502 can store an operating system and other applications, and when the technical schemes provided by the embodiments of this specification are implemented by software or firmware, the related program code is stored in the memory 1502 and is called and executed by the processor 1501 to perform the cloud-edge collaborative data processing method of any one of the embodiments of the present disclosure;
an input/output interface 1503 for realizing information input and output;
a communication interface 1504 for realizing communication and interaction between this device and other devices, which may be achieved through wired methods (such as USB, network cables, etc.) or wireless methods (such as mobile networks, Wi-Fi, Bluetooth, etc.); and
a bus 1505 for communicating information between various components (such as the processor 1501, memory 1502, input/output interface 1503, and communication interface 1504) of the device;
wherein, the processor 1501, the memory 1502, the input/output interface 1503, and the communication interface 1504 communicate with each other within the device via the bus 1505.

A further embodiment of the present disclosure provides a storage medium storing a computer program which, when executed by a processor, causes the processor to implement the above-described cloud-edge collaborative data processing method.

As a non-transitory storage medium, the memory can be configured to store a non-transitory software program and a non-transitory computer-executable program. In addition, the memory can include a high-speed random access memory and a non-transitory memory, for example, at least one magnetic disk storage device, a flash memory device, or another non-transitory solid-state storage device. In some implementations, the memory can include memories remotely located with respect to the processor, and these remote memories can be connected to the processor via a network. Examples of the above-mentioned network include, but are not limited to, the Internet, an intranet, a local area network, a mobile communication network, and a combination thereof.

According to the cloud-edge collaborative data processing method and system, the device, and the storage medium proposed by the embodiments of the present disclosure, data to be processed is acquired from a terminal device and sent to the edge encoder for feature extraction to obtain intermediate features. Next, for each processing task, the intermediate features are input into the lightweight edge decoder for decoding to obtain an edge decoding result, and an entropy of the edge decoding result is calculated as feature uncertainty. In response to the feature uncertainty being less than or equal to a preset threshold, the edge decoding result is taken as a target processing result corresponding to the processing task for the data to be processed, or in response to the feature uncertainty being greater than the preset threshold, feature compression is performed on the intermediate features using the edge compression model to obtain intermediate compressed features, and the intermediate compressed features are sent to a cloud server in the cloud-edge collaborative data processing system. The intermediate compressed features are decompressed on the cloud server to obtain intermediate decompressed features, and the intermediate decompressed features are decoded to obtain a cloud decoding result, which is taken as the target processing result corresponding to the processing task. In the embodiments of the present disclosure, the cloud-edge collaborative data processing model is segmented, with one part of the processing occurring at the edge and the other part occurring at the cloud. Through this segmented processing, the data to be processed is transformed into intermediate features of smaller dimensions, and then these intermediate features are compressed to further reduce the amount of data sent from the edge to the cloud, thereby reducing communication overhead. In addition, for different processing tasks, a lightweight model is used first to calculate a quick result, and based on the entropy of that result, it is determined whether to select the processing result from the edge or the processing result from the cloud. This flexible dynamic exit mechanism for cloud-edge collaboration selectively compresses part of the data from the full dataset for transmission, which can further reduce the data volume and communication overhead.

The embodiments described in the present disclosure are intended for more clearly describing the technical schemes of the embodiments of the present disclosure, and do not constitute a limitation on the technical schemes provided by the embodiments of the present disclosure. Those of ordinary skill in the art may understand that, with evolution of the technique and emergence of new application scenarios, the technical schemes provided by the embodiments of the present disclosure are also applicable to similar technical problems.

A person skilled in the art may understand that the technical schemes shown in the figures do not constitute a limitation on the embodiments of the present disclosure, and may include more or fewer steps than those shown in the figures, or combine some steps, or include different steps.

The apparatus embodiments described above are only for illustration. The units described as separate components may or may not be physically separated, that is, they may be located at one place or distributed to multiple network units. Some or all of the modules can be selected according to actual needs to achieve the objective of the schemes of the embodiments of the present disclosure.

It can be understood by those of ordinary skill in the art that all or some of the steps of the methods, systems and functional modules/units in the devices disclosed above can be implemented in hardware, firmware, or a combination of hardware and software.

The terms “first”, “second”, “third”, “fourth”, etc. (if any) in the specification and the above-mentioned drawings of the present disclosure are intended to distinguish similar objects and are not necessarily to describe a specific order or sequence. It should be understood that the ordinal numerals used in such a way can be interchanged where appropriate so that the embodiments of the present disclosure described herein can be implemented in an order other than those illustrated or described herein. Further, the terms “include” and “have” and any variations thereof are intended to encompass non-exclusive inclusion. For example, a process, method, system, product, or device that includes a series of steps or components is not limited to those steps or components explicitly listed, but may include additional steps or components that are not explicitly listed or that are inherent to such processes, methods, products, or devices.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between associated objects before and after the character. “At least one of” or similar expressions refers to any combination of these items, including any combination of single items or plural items. For example, at least one of a, b, or c may indicate: a, b, c, “a and b”, “a and c”, “b and c”, or “a and b and c”, where a, b, or c may be singular or plural.

In the embodiments provided by the present disclosure, it should be understood that the disclosed device and method can be realized in alternative ways. For example, the device embodiments described above are only for illustration. For example, the division of the units is only a logic function division. In actual implementation, there may be alternative manners for the division, for example, multiple units or components may be combined or integrated into another system, or some features may be omitted or not implemented. Further, the mutual coupling or direct coupling or communication connection shown or discussed may be indirect coupling or communication connection through some interfaces, devices or units, and may be in electrical, mechanical or other forms.

The above units described as separate components may or may not be physically separated, and the components displayed as units may or may not be physical units, that is, they may be located in one place or distributed to multiple network units. Some or all of the units can be selected according to actual needs to achieve the objective of the embodiments of the present disclosure.

In addition, the functional units in each embodiment of the present disclosure may be integrated into one processing unit, or each unit may be physically separate, or two or more units may be integrated into one unit. The integration unit can be realized either in the form of hardware or in the form of a software functional unit.

If the integrated units are implemented in the form of functional units of software and sold or used as independent products, they can be stored in a computer-readable storage medium. On the basis of such understanding, the substance or the parts that contribute to the existing technology or all or a part of the technical schemes of the present disclosure may be embodied in the form of a software product, which is stored in a storage medium and includes a number of instructions to cause a computer device (which can be a personal computer, a server, or a network device, etc.) to execute all or some of the steps of the method described in the embodiments of the present disclosure. The aforementioned storage medium includes: various media that can store programs, such as a USB flash drive, a mobile hard disk, a read-only memory (ROM), a random access memory (RAM), a magnetic disk or an optical disk.

Several embodiments of the present disclosure have been described above with reference to the accompanying drawings and are not to limit the scope of the present disclosure. Any modifications, equivalent substitutions, and improvements made by those of ordinary skill in the art without departing from the scope and essence of the present disclosure shall fall within the scope of the present disclosure.

What is claimed is:

1. A cloud-edge collaborative data processing method applied to an edge server in a cloud-edge collaborative data processing system, an edge encoder, at least one lightweight edge decoder each corresponding to a respective one of a plurality of processing tasks, and an edge compression model being deployed on the edge server, the method comprising:
acquiring data to be processed from a terminal device and sending the data to be processed to the edge encoder for feature extraction to obtain an intermediate feature;
for each processing task, performing the following steps:
inputting the intermediate feature into a respective lightweight edge decoder for decoding to obtain an edge decoding result, and calculating an entropy of the edge decoding result as a feature uncertainty;
in response to the feature uncertainty being less than or equal to a preset threshold, taking the edge decoding result as a target processing result corresponding to such processing task for the data to be processed; and
in response to the feature uncertainty being greater than the preset threshold, performing feature compression on the intermediate feature with the edge compression model to obtain an intermediate compressed feature, and sending the intermediate compressed feature to a cloud server in the cloud-edge collaborative data processing system,
wherein a cloud decompression model and at least one cloud decoder that together with the edge encoder constitutes a cloud-edge collaborative data processing model are deployed on the cloud server, each of the at least one lightweight edge decoder corresponds to a respective one of the at least one cloud decoder, the cloud decompression model is configured to decompress the intermediate compressed feature to obtain an intermediate decompressed feature, and each of the at least one cloud decoder is configured to decode the intermediate decompressed feature to obtain a cloud decoding result, which is taken as the target processing result corresponding to the processing task.

2. The cloud-edge collaborative data processing method of claim 1, wherein the edge compression model comprises at least a quantization model, and performing feature compression on the intermediate feature with the edge compression model to obtain the intermediate compressed features comprises:
quantizing the intermediate feature with the quantization model to obtain an intermediate quantized feature; and
performing arithmetic encoding on the intermediate quantized feature to obtain the an intermediate compressed feature in the form of a binary string.

3. The cloud-edge collaborative data processing method of claim 2, wherein the edge compression model comprises at least a side information encoder, a statistical parameter encoder, and a side information decoder, and performing feature compression on the intermediate feature with the edge compression model to obtain the intermediate compressed feature comprises:
inputting the intermediate feature into the side information encoder for feature correction to obtain a statistical hidden feature, and quantizing the statistical hidden feature to obtain a quantized hidden feature;
inputting the quantized hidden feature into the statistical parameter encoder for encoding to obtain a side information compressed feature;
inputting the quantized hidden feature into the side information decoder for decoding to obtain a statistical parameter, and correcting the intermediate quantized feature with the statistical parameter to obtain a simulated compressed feature; and
obtaining the intermediate compressed feature based on the simulated compressed feature and the side information compressed feature.

4. The cloud-edge collaborative data processing method of claim 3, further comprising:
designating at least one of the edge encoder, the at least one lightweight edge decoder, and the edge compression model as a first base network;
acquiring at least one of a first convolutional layer parameter of a convolutional layer or a first fully connected layer parameter of a fully connected layer in the first base network, and performing singular value decomposition on the first convolutional layer parameter and/or the first fully connected layer parameter to obtain a first singular value matrix and a first default matrix;
acquiring a predetermined first delta value, obtaining a first compression matrix based on the first delta value and the first singular value matrix, and obtaining a first compression model parameter based on the first compression matrix and the first default matrix; and
performing parameter update on the first base network based on the first compression model parameter to obtain an updated first base network.

5. A cloud-edge collaborative data processing method applied to a cloud server in a cloud-edge collaborative data processing system, a cloud decompression model and at least one cloud decoder that together with an edge encoder constitutes a cloud-edge collaborative data processing model being deployed on the cloud server, the method comprising:
receiving an intermediate compressed feature sent from an edge server, wherein the intermediate compressed feature is obtained by the cloud-edge collaborative data processing method of claim 1;
decompressing the intermediate compressed feature with the cloud decompression model to obtain an intermediate decompressed feature; and
for each of the plurality of processing tasks, selecting, a respective cloud decoder, and inputting the intermediate decompressed feature into the respective cloud decoder for decoding to obtain a cloud decoding result, which is taken as a target processing result corresponding to such processing task.

6. The cloud-edge collaborative data processing method of claim 5, wherein the cloud decompression model comprises at least a cloud side information decoder and a statistical parameter decoder, and in response to the intermediate compressed feature being obtained from the simulated compressed feature and the side information compressed feature, decompressing the intermediate compressed feature with the cloud decompression model to obtain the intermediate decompressed feature comprises:
acquiring the simulated compressed feature and the side information compressed feature from the intermediate compressed feature;
inputting the side information compressed feature into the statistical parameter decoder for decoding to obtain a decoded hidden feature;
inputting the decoded hidden feature into the cloud side information decoder for decoding to obtain a cloud statistical parameter; and
performing arithmetic decoding on the simulated compressed feature with the cloud statistical parameter to obtain the intermediate decompressed feature.

7. The cloud-edge collaborative data processing method of claim 6, further comprising:
designating at least one of the cloud decompression model or the at least one cloud decoder as a second base network;
acquiring at least one of a second convolutional layer parameter of a convolutional layer or a second fully connected layer parameter of a fully connected layer in the second base network, and performing singular value decomposition on the second convolutional layer parameter and/or the second fully connected layer parameter respectively to obtain a second singular value matrix and a second default matrix;
acquiring a predetermined second delta value, obtaining a second compression matrix based on the second delta value and the second singular value matrix, and obtaining a second compression model parameter based on the second compression matrix and the second default matrix; and
performing parameter update on the second base network based on the second compression model parameter to obtain an updated second base network.

8. A cloud-edge collaborative data processing system, comprising:
an edge server, on which an edge encoder, at least one lightweight edge decoder each corresponding to a respective one of a plurality of processing tasks, and an edge compression model are deployed; and
a cloud server, on which a cloud decompression model and at least one cloud decoder are deployed, the at least one cloud decoder and the edge encoder together constituting a cloud-edge collaborative data processing model, and each of the at least one cloud decoder corresponding to a respective one of the at least one lightweight edge decoder, wherein
the edge server is configured to perform feature extraction with the edge encoder on the data to be processed from a terminal device to obtain an intermediate feature, decode, with the at least one lightweight edge decoder, the intermediate feature input thereto to obtain an edge decoding result, calculate an entropy of the edge decoding result as a feature uncertainty, and take the edge decoding result as a target processing result for the data to be processed in response to the feature uncertainty being less than or equal to a preset threshold, or perform feature compression on the intermediate feature with the edge compression model to obtain an intermediate compressed feature in response to the feature uncertainty being greater than the preset threshold, and send the intermediate compressed feature to the cloud server; and
the cloud server is configured to decompress the intermediate compressed feature with the cloud decompression model to obtain an intermediate decompressed feature, and for at least one of the plurality of processing tasks, select at least one respective cloud decoder, and input the intermediate decompressed feature into the cloud decoder for decoding to obtain a cloud decoding result, which is taken as a target processing result corresponding to such processing task.

9. The cloud-edge collaborative data processing system of claim 8, wherein a training process of the edge encoder, the edge compression model, the cloud decompression model, and the at least one cloud decoder comprises the steps of:
acquiring input sample data;
during the training process, acquiring intermediate training data corresponding to the input sample data, acquiring transmission mutual information of the input sample data and the intermediate training data, and generating an information quantity constraint based on a maximum information quantity and the transmission mutual information;
acquiring a plurality of cloud inference results each corresponding to a respective one of the plurality of processing tasks based on the intermediate training data, generating a plurality of items of inference mutual information each between a respective one of the plurality of cloud inference results and the intermediate training data, and maximizing, based on a plurality of Lagrange multipliers each corresponding to each of the plurality of processing tasks, each of the plurality of items of inference mutual information to obtain a compression objective;
obtaining an optimization objective based on the transmission mutual information and the compression objective;
obtaining a loss function and an objective upper bound corresponding to the optimization objective based on the input sample data, the intermediate training data, and the plurality of cloud inference result; and
under the premise of satisfying the objective upper bound and the information quantity constraint, minimizing a loss value corresponding to the loss function to train the edge encoder, the edge compression model, the cloud decompression model, and the at least one cloud decoder.

10. An electronic device comprising a memory and a processor, wherein the memory stores a computer program, and the computer program, when executed by the processor, causes the processor to implement the cloud-edge collaborative data processing method of claim 1.

11. A non-transitory computer-readable storage medium storing a computer program, wherein the computer program, when executed by a processor, causes the processor to implement a cloud-edge collaborative data processing method applied to an edge server in a cloud-edge collaborative data processing system, wherein an edge encoder, at least one lightweight edge decoder each corresponding to a respective one of a plurality of processing tasks, and an edge compression model are deployed on the edge server, wherein the method comprises:
acquiring data to be processed from a terminal device and sending the data to be processed to the edge encoder for feature extraction to obtain an intermediate feature;
for each processing task, performing the following steps:
inputting the intermediate feature into a respective lightweight edge decoder for decoding to obtain an edge decoding result, and calculating an entropy of the edge decoding result as a feature uncertainty;
in response to the feature uncertainty being less than or equal to a preset threshold, taking the edge decoding result as a target processing result corresponding to such processing task for the data to be processed; and
in response to the feature uncertainty being greater than the preset threshold, performing feature compression on the intermediate feature with the edge compression model to obtain an intermediate compressed feature, and sending the intermediate compressed feature to a cloud server in the cloud-edge collaborative data processing system,
wherein a cloud decompression model and at least one cloud decoder that together with the edge encoder constitutes a cloud-edge collaborative data processing model are deployed on the cloud server, each of the at least one lightweight edge decoder corresponds to a respective one of the at least one cloud decoder, the cloud decompression model is configured to decompress the intermediate compressed feature to obtain an intermediate decompressed feature, and each of the at least one cloud decoder is configured to decode the intermediate decompressed feature to obtain a cloud decoding result, which is taken as the target processing result corresponding to the processing task.

12. The non-transitory computer-readable storage medium of claim 11, wherein the edge compression model comprises at least a quantization model, and performing feature compression on the intermediate feature with the edge compression model to obtain the intermediate compressed features comprises:
quantizing the intermediate feature with the quantization model to obtain an intermediate quantized feature; and
performing arithmetic encoding on the intermediate quantized feature to obtain the an intermediate compressed feature in the form of a binary string.

13. The non-transitory computer-readable storage medium of claim 12, wherein the edge compression model comprises at least a side information encoder, a statistical parameter encoder, and a side information decoder, and performing feature compression on the intermediate feature with the edge compression model to obtain the intermediate compressed feature comprises:
inputting the intermediate feature into the side information encoder for feature correction to obtain a statistical hidden feature, and quantizing the statistical hidden feature to obtain a quantized hidden feature;
inputting the quantized hidden feature into the statistical parameter encoder for encoding to obtain a side information compressed feature;
inputting the quantized hidden feature into the side information decoder for decoding to obtain a statistical parameter, and correcting the intermediate quantized feature with the statistical parameter to obtain a simulated compressed feature; and
obtaining the intermediate compressed feature based on the simulated compressed feature and the side information compressed feature.

14. The non-transitory computer-readable storage medium of claim 13, further comprising:
designating at least one of the edge encoder, the at least one lightweight edge decoder, and the edge compression model as a first base network;
acquiring at least one of a first convolutional layer parameter of a convolutional layer or a first fully connected layer parameter of a fully connected layer in the first base network, and performing singular value decomposition on the first convolutional layer parameter and/or the first fully connected layer parameter to obtain a first singular value matrix and a first default matrix;
acquiring a predetermined first delta value, obtaining a first compression matrix based on the first delta value and the first singular value matrix, and obtaining a first compression model parameter based on the first compression matrix and the first default matrix; and
performing parameter update on the first base network based on the first compression model parameter to obtain an updated first base network.

15. A non-transitory computer-readable storage medium storing a computer program, wherein the computer program, when executed by a processor, causes the processor to implement a cloud-edge collaborative data processing method of claim 5.

16. A non-transitory computer-readable storage medium storing a computer program, wherein the computer program, when executed by a processor, causes the processor to implement a cloud-edge collaborative data processing method of claim 6.

17. A non-transitory computer-readable storage medium storing a computer program, wherein the computer program, when executed by a processor, causes the processor to implement a cloud-edge collaborative data processing method of claim 7.
